(19) United States
(12) Patent Application Publication
(10) Pub. No.: US 2008/0098263 A1
(43) Pub. Date: Apr. 24, 2008

(54) Test apparatus and method for testing booting and shutdown process of computer system

(75) Inventor: Po-Chih Yen, Taipei (TW)

Correspondence Address: BACON & THOMAS, PLLC, 625 SLATERS LANE, FOURTH FLOOR, ALEXANDRIA, VA, 22314, US

(73) Assignee: ASUSTek COMPUTER INC., Taipei (TW)

(21) Appl. No.: 11/907,727

(22) Filed: Oct. 17, 2007

(30) Foreign Application Priority Data
Oct. 18, 2006 (TW) 95138439

(51) Int. Cl. G06F 11/22

(52) U.S. Cl. 714/36; 714/E11.149

(57) ABSTRACT

A test apparatus for testing a booting and shutdown process of a computer system provided. The test apparatus includes a power control unit and a test control unit. The power control unit is for receiving AC power, and selectively outputting the AC power to a power supply end of the computer system. The test control unit outputs a power control signal to the power control unit, for controlling the power control unit to output the AC power to the power supply end. The test control unit then tests the booting and shutdown process of the computer system. The test control unit receives a test result data transferred from the computer system and determines whether the booting and shutdown process is correct.

This application claims the benefit of Taiwan application Serial No. 95138439, filed Oct. 18, 2006, the subject matter of which is incorporated herein by reference.

### BACKGROUND OF THE INVENTION

1. Field of the Invention

The invention relates to a test apparatus and, more particularly, to a test apparatus for testing a booting and shutdown process of a computer system.

2. Description of the Related Art

Before a computer system product goes out of a factory, a series of tests for booting and shutdown processes are needed to examine any possible problem during the processes to improve the reliability and the life of the product. A conventional test apparatus can automatically test the booting and shutdown processes of the computer system and it does not need to boot and shut down the computer system manually, so that the cost is saved and the efficiency of the production is increased.

However, the conventional test apparatus tests the booting and shutdown processes of the computer system according to a predetermined time period within which the computer system is supplied with test power to boot and shut down the computer system. When the predetermined time period is up, supplying of the test power to the computer system is stopped, the test result is recorded, and the next test for booting and shutdown process is continued. These steps may be repeated until predetermined test times are achieved.

When the computer system is supplied with the test power exceeding the predetermined time period, no matter whether the computer system finishes the booting process, supplying of the test power to the computer system may be stopped. Therefore, when the computer system fails to finish the booting and shutdown process within the predetermined time period, the conventional test apparatus can not verify whether the booting and shutdown process of the computer system is correct. Therefore, the reliability of the test for the booting and shutdown process by the conventional test apparatus needs to be improved.

Furthermore, AC power is directly inputted to a power supply end of the computer system for supplying power during the test process of the conventional test apparatus. When the AC power is inputted to the power supply end of the computer system, the computer system is supplied with standby power permanently to boot parts of the computer system, such as a basic input/output system (BIOS), a North Bridge, a South Bridge, and a Local Area Network. Therefore, only when the computer system is supplied with the standby power, the conventional test apparatus can supply the computer system with the test power to test the booting and shutdown process of the computer system by a warm booting method. Consequently, before the conventional test apparatus supplies the computer system with the test power to test the booting and shutdown process next time, parts of the computer system have been already booted. Therefore, the conventional test apparatus only can test parts of the booting and shutdown process and can not completely examine all the possible problems of the computer system.

Further, the present computer system widely introduces a Windows operation system (Windows), and it is necessary to test the booting and shutdown process of the Windows. However, the conventional test apparatus only can verify whether the booting and shutdown process of a disc operating system (DOS) is regular, while it can not test the booting and shutdown process of the Windows. Therefore, the use of the conventional test apparatus to test the present computer system is out of date and does not satisfy the present industry.

### BRIEF SUMMARY OF THE INVENTION

The objective of the invention is to provide a test apparatus determining whether a booting and shutdown process of a computer system is normal according to test result data transferred from the tested computer system. If the booting and shutdown process is normal, supplying of AC power to the computer system is stopped so that no power is supplied to the computer system. Therefore, the test apparatus can completely test the booting and shutdown process of the computer system next time.

According to the objective of the invention, a test apparatus is provided to test a booting and shutdown process of a computer system. The testing apparatus includes a power control unit and a test control unit. The power control unit is for receiving AC power and selectively outputting the AC power to a power supply end of the computer system. The test control unit is for outputting a power control signal to the power control unit to control the power control unit to output the AC power to the power supply end, then testing the booting and shutdown process of the computer system, and receiving test result data transferred from the computer system. The power control signal corresponds to the test result data.

According to the objective of the invention, a method for testing a booting and shutdown process of a computer system is provided, wherein the method is used in a test apparatus. The test apparatus includes a power control unit. The method includes the following steps. First, AC power is supplied to the computer system via the power control unit to test the booting and shutdown process of the computer system. Second, a booting program is executed in the computer system. Then whether the computer system is successfully booted is determined. After that, according to the step of whether the computer system is successfully booted, the power control unit is controlled to electrically isolate the computer system from the AC power.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing a test apparatus according to an embodiment of the invention.

FIG. 2 is a flow diagram showing that a test apparatus tests a booting and shutdown process of a disc operating system (DOS) for a computer system according to an embodiment of the invention.

FIG. 3 is a flow diagram showing that a testing apparatus tests a booting and shutdown process of a Windows operation system (Windows) for a computer system according to an embodiment of the invention.

### DETAILED DESCRIPTION OF THE EMBODIMENTS

A test apparatus according to the invention is for testing a booting and shutdown process of a computer system. The test apparatus includes a power control unit and a test control unit. The power control unit is for receiving AC power and selectively outputting the AC power to a power supply end of the computer system. The test control unit is for outputting a power control signal to the power control unit to control the power control unit to output the AC power to the power supply end, then testing the booting and shutdown process of the computer system, and receiving test result data transferred from the computer system. The power control signal corresponds to the test result data.

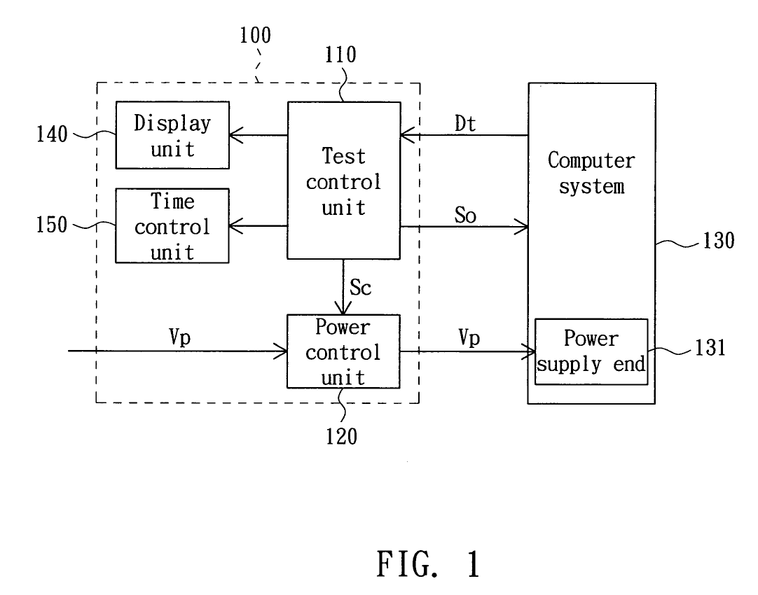

FIG. 1 is a block diagram showing a test apparatus according to an embodiment of the invention. A test apparatus 100 for testing a booting and shutdown process of a computer system 130 includes a test control unit 110 and a power control unit 120. The test control unit 110, such as a micro processing unit (MPU), is for controlling a test program of the booting and shutdown process of the computer system 130 and outputting a power control signal Sc to the power control unit 120. The power control unit 120, such as a solid state relay (SSR), is coupled to a power supply end 131 of the computer system 130 and is for receiving AC power Vp. According to the power control signal Sc, the power control unit 120 determines whether the AC power Vp is to be transferred to the power supply end 131 of the computer system 130.

In a preferred embodiment, the test apparatus may be for testing a booting and shutdown process of a disc operating system (DOS) and a Windows operation system (Windows) of a computer system. Thereinafter two examples are provided.

Here it is described that the test apparatus 100 tests the booting and shutdown process of the DOS for the computer system 130. The test control unit 110 may output the power control signal Sc to the power control unit 120, so that the power control unit 120 may transfer the AC power Vp to the power supply end 131 of the computer system 130. Then the computer system 130 may execute a DOS booting program to boot the DOS.

After the computer system 130 finishes the DOS booting process, it may transfer test result data Dt to the test control unit 110. The test result data Dt may include the test result of the DOS booting process of the computer system 130.

According to the test result data Dt, the test control unit 110 may determine whether the boot process of the computer system 130 is normal. After the DOS booting process of the computer system, the shutdown can be achieved only by the cutting-off of the supply power of the computer system. Therefore, if the booting process of the computer system 130 is normal, the test control unit 110 may output the power control signal Sc to control the power control unit 120 to stop supplying the AC power Vp to the power supply end 131, so that the AC power Vp may be electrically isolated from the power supply end 131. The test control unit 110 may selectively proceed with the next test of the booting and shutdown process of the computer system 130.

Here it is described that the test apparatus 100 tests the booting and shutdown process of the Windows for the computer system 130. The test control unit 110 may output the power control signal Sc to the power control unit 120, so that the power control unit 120 may transfer the AC power Vp to the power supply end 131 of the computer system 130. Then the computer system 130 may execute a Windows booting program to boot the Windows.

After the computer system 130 finishes the Windows booting process, it may transfer test result data Dt to the test control unit 110. The test result data Dt may include the test result of the Windows booting process of the computer system 130.

According to the test result data Dt, the test control unit 110 may determine whether the booting process of the computer system 130 is normal. The Windows need execute a Windows shutdown process, and the supplying of the power may be stopped until the system stores the data set by users. Therefore, if the Windows booting process of the computer system 130 is normal, the test control unit 110 may further output a shutdown control signal So to make the computer system 130 execute the Windows shutdown process. In this embodiment, when the computer system 130 receives the shutdown control signal So, which is similar to starting of a power key of the computer system 130, the computer system 130 may execute the Windows shutdown process.

After the computer system 130 finishes the Windows shutdown process, the computer system 130 may output the test result data Dt to the test control unit 110, and at this moment the test result data Dt may include the test data of the Windows shutdown result. According to the test result data Dt, the test control unit 110 may determine whether the shutdown process of the computer system 130 is correct.

If the Windows shutdown process of the computer system 130 is correct, the test control unit 110 may output the power control signal Sc to control the power control unit 120 to stop outputting the AC power Vp to the power supply end 131, so that the AC power Vp may be electrically isolated from the power supply end 131. The test control unit 110 may selectively proceed with the next test of the booting and shutdown process of the computer system 130.

Additionally, the test apparatus 100 may further include a display unit 140 for displaying the test result corresponding to the test result data Dt, such as the times of successful booting.

Furthermore, because the computer system 130 needs some time to finish the booting process, it may have to be supplied with the AC power Vp for some time. Therefore, the testing apparatus 100 may further include a time control unit 150 for setting power-supplying time and power-cutting-off time. The power-supplying time is the time length that the power control unit 120 continuously outputs the AC power Vp to the power supply end 131 to boot the computer system 130. The power-cutting-off time is the time length that the power control unit 120 isolates the AC power Vp from the power supply end 131 to electrically isolate the computer system 130.

In a preferred embodiment, after every test of the booting and shutdown process of the computer system 130, the test apparatus may electrically isolate the AC power Vp from the computer system 130 by controlling the power control unit 120. Therefore, while selectively proceeding with the next test of the booting and shutdown process of the computer system 130, the test apparatus 100 can completely test the booting and shutdown process of the computer system 130 beginning with the first initial state that no power is supplied to the computer system 130.

Compared with the invention, after testing the booting and shutdown process of the computer system, the conventional test apparatus re-tests the booting and shutdown process only by a warm booting method. In the conventional test apparatus, only the test power instead of the AC power is cut off before the next test for the booting and shutdown process, so that the computer system is still supplied with standby power. When the computer system is supplied with the standby power, that is, parts of the booting process are executed, the conventional test apparatus fails to test the booting process of the computer system at this moment. As mentioned above, the test apparatus according to the embodiment of the invention can completely test the booting and shutdown process of the computer system to raise the reliability of the test.

Additionally, the test control unit 110 controls the power control unit 120 according to the test result data Dt. The test control unit 110 outputs the power control signal Sc corresponding to the test result data Dt to determine whether the power control unit 120 is to stop supplying the AC power Vp to the computer system 130. If a computer system is tested by a conventional test apparatus, even if the computer system does not finish the test for the booting and shutdown process, as long as the predetermined time period is up, the conventional test apparatus may stop supplying the test power to the computer system. Therefore, when the computer system fails to finish the booting and shutdown process within the predetermined time period, the conventional test apparatus can not test whether the booting and shutdown process of the computer system is correct. Compared with the conventional test apparatus, in this embodiment, the test apparatus 100 determines whether the booting and shutdown process of the computer system 130 is normal according to the test result data Dt transferred from the computer system 130, and therefore the booting and shutdown process of the computer system 130 can be accurately tested.

Furthermore, in this embodiment, the test apparatus transfers the test result data Dt from the computer system 130 to the test apparatus 100 via a standard interface, such as a universal serial bus (USB) interface or a component object model (COM) port interface.

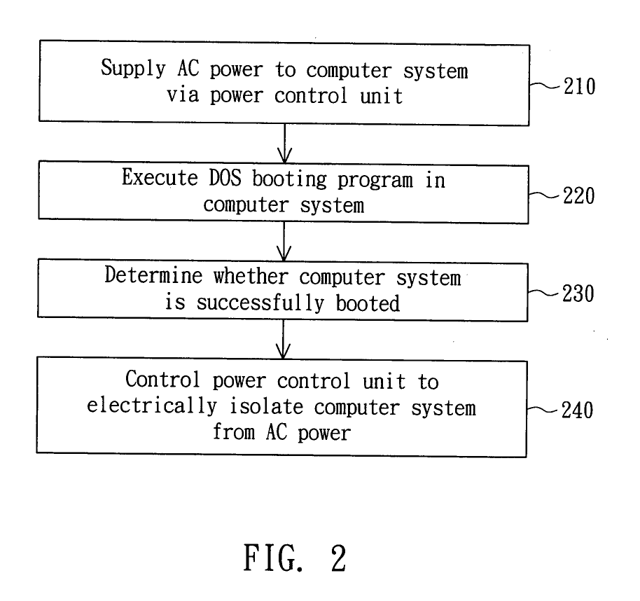

FIG. 2 is a flow diagram showing that the test apparatus in FIG. 1 tests a booting and shutdown process of a DOS for a computer system. First, in step 210, the AC power Vp is supplied to the computer system 130 via the power control unit 120 to test the booting and shutdown process of the computer system 130. Second, in step 220, a DOS booting program is executed in the computer system 130. Then in step 230, whether the computer system 130 is successfully booted is determined. Finally, in step 240, the power control unit 120 is controlled to electrically isolate the computer system 130 from the AC power Vp.

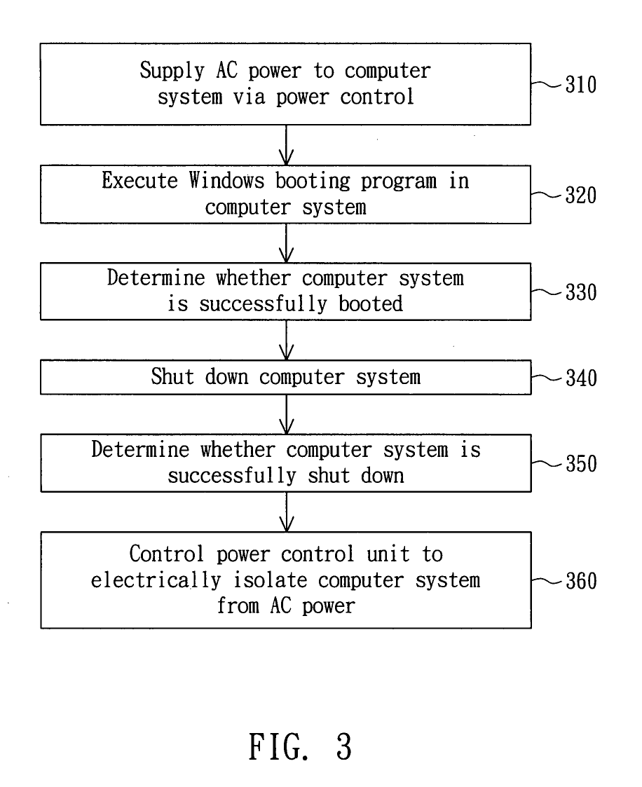

FIG. 3 is a flow diagram showing that a test apparatus tests a booting and shutdown process of a Windows for a computer system according to an embodiment of the invention. First, in step 310, the AC power Vp is supplied to the computer system 130 via the power control unit 120 to test the booting and shutdown process of the computer system 130. Second, in step 320, a Windows booting program is executed in the computer system 130. Then, in step 330, whether the computer system 130 is successfully booted is determined. After that, in step 340, the computer system 130 is shut down. In step 350, whether the computer system 130 is successfully shut down is determined. Finally, in step 360, the power control unit 120 is controlled to electrically isolate the computer system 130 from the AC power Vp.

In this embodiment, the test apparatus determines whether the booting and shutdown process of the computer system is normal according to the test result data transferred from the tested computer system. If the booting and shutdown process of the tested computer system is normal, the outputting of the AC power to the computer system is stopped. Therefore, while proceeding with the next test of the booting and shutdown process, the test apparatus can completely test the booting and shutdown process of the computer system beginning with the first initial state that no power is supplied to the computer system.

Furthermore, in a preferred embodiment, the test apparatus can test not only the DOS booting process but also the Windows booting process of the computer system. After the Windows booting process of the computer system finishes, the test apparatus may control the shutdown process of the computer system to determine whether the shutdown process is normal. Therefore, the test for the booting and shutdown process of the computer system by the test apparatus is more similar to an actual operation for the computer system by a user. Therefore the test apparatus can accurately test the booting and shutdown process of the computer system and examine the errors possibly occurring in the booting and shutdown process of the computer system.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A test apparatus for testing a booting and shutdown process of a computer system, the test apparatus comprising:
a power control unit for receiving AC power and selectively outputting the AC power to a power supply end of the computer system; and
a test control unit for outputting a power control signal to the power control unit to control the power control unit to output the AC power to the power supply end, then testing the booting and shutdown process of the computer system, and receiving test result data transferred from the computer system, wherein the power control signal corresponds to the test result data.

2. The test apparatus according to claim 1, the test apparatus further comprising a time control unit for setting power-supplying time, wherein the power-supplying time is the time length that the power control unit continuously outputs the AC power to the power supply end.

3. The test apparatus according to claim 1, the test apparatus further comprising a display unit for displaying the test result corresponding to the test result data.

4. The test apparatus according to claim 1, wherein the test result data is transferred from the computer system to the test apparatus via a standard interface.

5. The test apparatus according to claim 1, wherein the standard interface is a universal serial bus (USB) interface or a component object model (COM) port interface.

6. The test apparatus according to claim 1, wherein after the test of the booting and shutdown process, the power control signal is outputted to electrically isolate the computer system from the AC power.

7. The test apparatus according to claim 1, wherein the test control unit further outputs a shutdown control signal to the computer system to control the shutdown process of the computer system.

8. A method for testing a booting and shutdown process of a computer system, wherein the method is used in a test apparatus comprising a power control unit, the method comprising:
supplying AC power to the computer system via the power control unit to test the booting and shutdown process of the computer system;
executing a booting program in the computer system;
determining whether the computer system is successfully booted; and
if the computer system is successfully booted, controlling the power control unit to electrically isolate the computer system from the AC power.

9. The method for testing a booting and shutdown process of a computer system according to claim 8, the test apparatus further comprising a test control unit, wherein in the step of supplying the AC power to the computer system, the test control unit outputs a power control signal to control the power control unit to input the AC power to the computer system.

10. The method for testing a booting and shutdown process of a computer system according to claim 9, wherein in the step of determining whether the computer system is successfully booted, the test control unit is used to determine whether the computer system is successfully booted.

11. The method for testing a booting and shutdown process of a computer system according to claim 9, wherein in the step of electrically isolating the computer system from the AC power, the test control unit outputs the power control signal to electrically isolate the computer system from the AC power.

12. The method for testing a booting and shutdown process of a computer system according to claim 8, wherein in the step of executing the booting program, the booting program is a disc operating system (DOS) booting program.

13. The method for testing a booting and shutdown process of a computer system according to claim 8, wherein in the step of executing the booting program, the booting program is a Windows operating system (Windows) booting program.

14. The method for testing a booting and shutdown process of a computer system according to claim 13, wherein the step of electrically isolating the computer system from the AC power further comprises:
shutting down the computer system; and
if the computer system is successfully shut down,
controlling the power control unit to electrically isolate the computer system from the AC power.
